(19) United States
(12) Patent Application Publication
(10) Pub. No.: US 2010/0325171 A1
(43) Pub. Date: Dec. 23, 2010

(54) SYSTEM AND METHOD FOR GATHERING AND ANALYZING LITIGATION MARKETPLACE INTELLIGENCE

(76) Inventors: Kenneth J. Lopez, Alexandria, VA (US); Daniel Bender, Washington, DC (US)

Correspondence Address: JACOBSON HOLMAN PLLC, 400 SEVENTH STREET N.W., SUITE 600, WASHINGTON, DC, 20004, US

(21) Appl. No.: 12/692,922

(22) Filed: Jan. 25, 2010

Related U.S. Application Data
(60) Provisional application No. 61/202,080, filed on Jan. 27, 2009.

(51) Int. Cl. G06F 17/30

(52) U.S. Cl. 707/803; 707/E17.005

(57) ABSTRACT

A system and method for gathering publicly-available litigation marketplace intelligence data for litigation support companies and law firms and about law firms, corporations, attorneys, and cases, and analyzing it. The litigation marketplace intelligence system and method employs an Internet-based, relational legal database (“IBLD”), which is hosted on a server, and maintained and administered by an IBLD Proprietor. Subscribers subscribe to the IBLD, which they access via an Internet connection to their local computer. A User associated with an IBLD Subscriber can create and save reports that select data fields and add criteria from any number of the Attorneys, Law Firms, Lawsuits, and G3K companies in the IBLD.

### CROSS-REFERENCE TO RELATED APPLICATIONS

The present patent application is based on, and claims priority from, U.S. provisional Application No. 61/202,080, filed Jan. 27, 2009, which is incorporated herein by reference in its entirety.

### COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to a system and method for gathering and analyzing litigation marketplace intelligence data. More specifically, the invention relates to a to a system and method for gathering and analyzing litigation marketplace intelligence data that facilitates transfer of data from court docket databases to a customer relationship management program using an online, on-demand productivity application.

2. Related Art

Early Case Assessment (“ECA”) is a concept that calls for the application of a business perspective to traditional legal issues, in order to uncover and implement cost-effective business solutions for formulating an efficient litigation plan. ECA requires researching attorneys and judge via databases containing news, dockets, litigation history reports, and attorney and judicial profiles. Both Westlaw and LexisNexis offer fee-based databases for researching news, litigation dockets, litigation history, and attorney and judicial profiles. Law firm and court Web sites provide additional sources of information.

However, a researcher must research each of these databases separately. None of the commercial databases provides a system or method for gathering and analyzing litigation marketplace intelligence data in an integrated fashion that facilitates transfer of data from court docket databases to a customer relationship management program using an online, on-demand productivity application.

It is to the solution of these and other problems that the present invention is directed.

### SUMMARY OF THE INVENTION

It is a primary object of the present invention to provide a system and method for gathering publicly-available litigation marketplace intelligence data for litigation support companies and law firms and about law firms, corporations, attorneys, and cases, and analyzing it.

These and other objects are achieved by a system and method for gathering and analyzing litigation marketplace intelligence data (hereafter referred to as the LMI system and/or method), for litigation support companies and law firms and about law firms, corporations, attorneys, and cases, and analyzing it. The litigation marketplace intelligence system and method employs an Internet-based, relational legal database (“IBLD”), which is hosted on a server, and maintained and administered by an IBLD Proprietor. Subscribers subscribe to the IBLD, which they access via an Internet connection to their local computer. A User associated with an IBLD Subscriber can create and save reports that select data fields and add criteria from any number of the Attorneys, Law Firms, Lawsuits and G3K companies in the IBLD.

Other objects, features and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1 is an illustration of the order of FIGS. 1A-1D FIGS. 1A-1D together are a flow diagram illustrating the steps carried out in the LMI method in accordance with the present invention.

FIG. 1E is a key to the symbols used in FIGS. 1A-1D.

FIG. 2 is an exemplary Subscriber-side home page for the Web-based user interface of the LMI system in accordance with the present invention.

FIG. 3 is an exemplary Subscriber side browser page for the Firms function of the LMI system's Web-based user interface.

FIGS. 3A and 3B show the drop-down menus indicated by 3A and 3B in FIG. 3.

FIG. 3C is an exemplary Subscriber side browser page for a firm selected from the browser page of FIG. 3.

FIG. 4 is an exemplary Subscriber side browser page for the Contacts function of the LMI system's Web-based user interface.

FIGS. 4A and 4B show the drop-down menus indicated by 4A and 4B in FIG. 4.

FIG. 4C is an exemplary Subscriber side browser page for a contact selected from the browser page of FIG. 4.

FIG. 5 is an exemplary Subscriber side browser page for the Parties function of the LMI system's Web-based user interface.

FIGS. 5A and 5B show the drop-down menus indicated by 5A and 5B in FIG. 5.

FIG. 5C shows portions of an exemplary Subscriber side browser page for a Party, retrieved by selecting a Party listed using the Parties function.

FIG. 6 is an exemplary Subscriber side browser page for the Matters function of the LMI system's Web-based user interface.

FIGS. 6A and 6B show the drop-down menus indicated by 6A and 6B in FIG. 6.

FIG. 7 is the top portion of an exemplary Subscriber side browser page for the Reports function of the LMI system's Web-based user interface.

FIG. 7A show the drop-down menu indicated by 7A in FIG. 7.

FIG. 7B is the top portion of an exemplary Subscriber side browser page for an exemplary “Clients & their firms/attorneys” report selected from the “Cases by Attorney Office” folder on the browser page of FIG. 7.

FIG. 7C is the top portion of an exemplary Subscriber side browser page for an exemplary “Contacts & associated cases” report selected from the “Cases by Attorney Office” folder on the browser page of FIG. 7.

FIG. 7D is the top portion of an exemplary Subscriber side browser page for an exemplary “Contacts & cases sorted by firm” report selected from the “Cases by Attorney Office” folder on the browser page of FIG. 7.

FIG. 7E shows portions of an exemplary Subscriber side browser page for an exemplary “Firms & associated cases” report selected from the “Cases by Attorney Office” folder on the browser page of FIG. 7.

FIG. 7F shows the top portion of an exemplary Subscriber side browser page for an exemplary “Firms & cases sorted by contact” report selected from the “Cases by Attorney Office” folder on the browser page of FIG. 7.

FIG. 7G shows portions of an exemplary Subscriber side browser page for an exemplary “Most active law firms” report selected from the “Cases by Attorney Office” folder on the browser page of FIG. 7.

FIG. 7H shows the top portion of an exemplary Subscriber side browser page for an exemplary “Partners & associated cases” report selected from the “Cases by Attorney Office” folder on the browser page of FIG. 7.

FIG. 71 shows portions of an exemplary Subscriber side browser page for an exemplary “SAMPLE [name of law firm]—Types of cases” report selected from the “Cases by Attorney Office” folder on the browser page of FIG. 7.

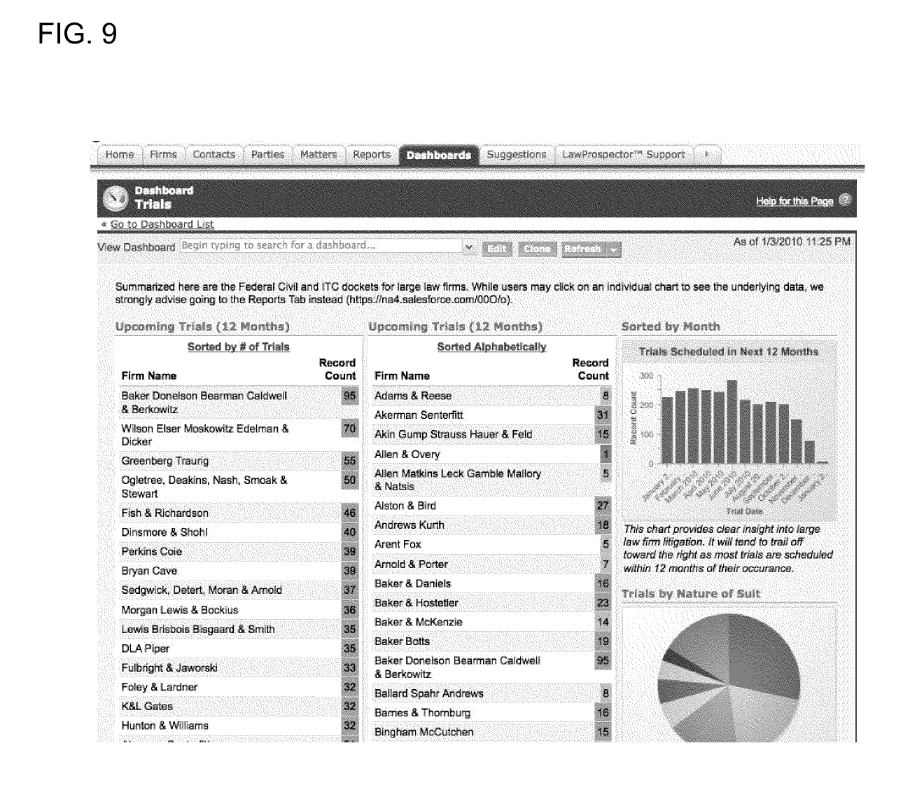

FIG. 8 shows an exemplary Subscriber side browser page for the Support function of the LMI system's Web-based user interface.

FIG. 9 shows an exemplary Subscriber side browser page for an exemplary Dashboard selected from a “Dashboard” tab.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

The present invention is described below with reference to flowchart illustrations of methods, apparatus (systems), and computer program products according to an embodiment of the invention. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

The present invention is preferably practiced within a client/server programming environment. As is known by those skilled in this art, client/server is a model for a relationship between two computer programs in which one program, the client, makes a service request from another program, the server, which fulfills the request. Although the client/server model can be used by programs within a single computer, it is more commonly used in a network where computing functions and data can more efficiently be distributed among many client and server programs at different network locations.

As is known to those with skill in this art, client/server environments may include public networks, such as the Internet, and private networks often referred to as “Intranets” and “Extranets.” The term “Internet” shall incorporate the terms “Intranet” and “Extranet” and any references to accessing the Internet shall be understood to mean accessing an Intranet and/or and Extranet, as well. The term “computer network” shall incorporate publicly accessible computer networks and private computer networks.

It is to be understood that the present invention is not limited to the illustrated user interfaces or to the order of the user interfaces described herein. Various types and styles of user interfaces may be used in accordance with the present invention without limitation.

The following definitions are used herein:

Data loader—a computer-implemented tool that imports and exports data from one database format to another database format, for example, MySQL, Oracle, MS Access, FoxPro, MS SQL Server, CSV, and Delimited or Flat Files. The data loader can import and export data via the Internet.

PACER—acronym for Public Access to Court Electronic Records, an electronic public access service of United States federal court documents, which is managed by the Administrative Office of the United States Courts and allows users to obtain case and docket information from the United States district courts, United States courts of appeals, and United States bankruptcy courts.

Web-based User Interface (WUI)—a computer interface that accepts input and provide output by generating web pages which are transmitted via the Internet and viewed by the user using a web browser program. Newer implementations utilize Java, AJAX, Adobe Flex, Microsoft .NET, or similar technologies to provide real time control in a separate program, eliminating the need to refresh a traditional HTML based web browser.

Web scraper—A computer program that extracts content such as e-mail addresses or other data from a Web site or search engine over HTTP, typically for the purpose of transforming that content into another format suitable for use in another context. Web scrapers use bots to cull the extracted data, which may be reorganized and presented in a unique manner.

The LMI system and method in accordance with the present invention employs an Internet-based, relational legal database (“IBLD”), which is hosted on a server, and maintained and administered by an IBLD Proprietor. The IBLD Proprietor has at least one Administrator and at least one Researcher to perform maintenance and administration of the IBLD. Work is divided between Administrators and Researchers based on efficiency and workflow considerations, so the division is flexible.

The IBLD tracks and provides information regarding the largest law firms in the United States (“Law Firms”), attorneys and other employees employed by Law Firms (collectively “Attorneys”), their large lawsuits, International Trade Commission hearings and investigations, arbitrations and mediations (collectively “Lawsuits”), and the approximately 3000 largest public and private companies worldwide (“G3K companies”). Subscribers (“Users”) subscribe to the IBLD, which they access via an Internet connection to their local computer.

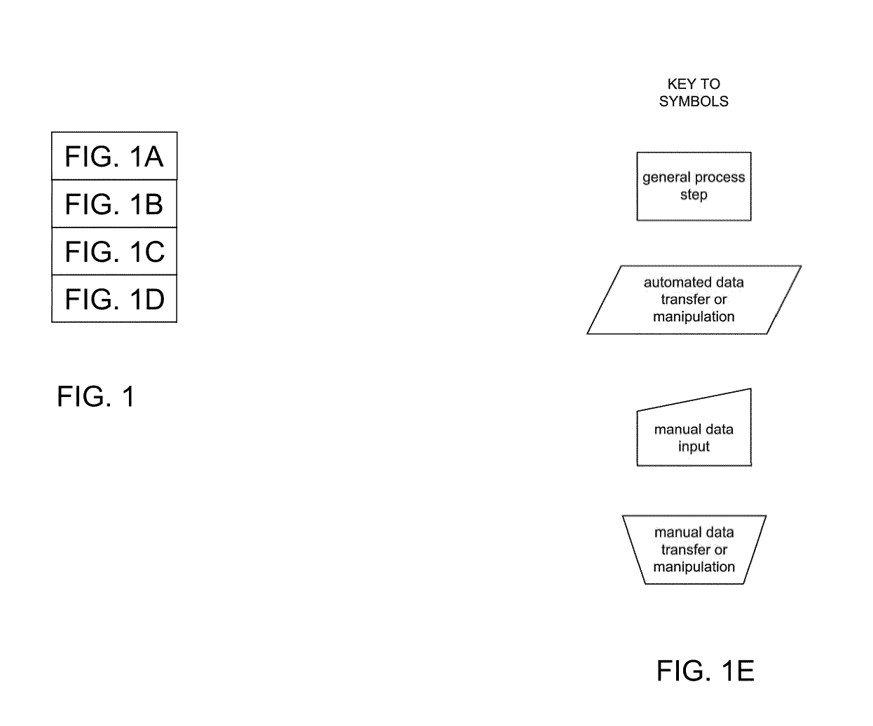

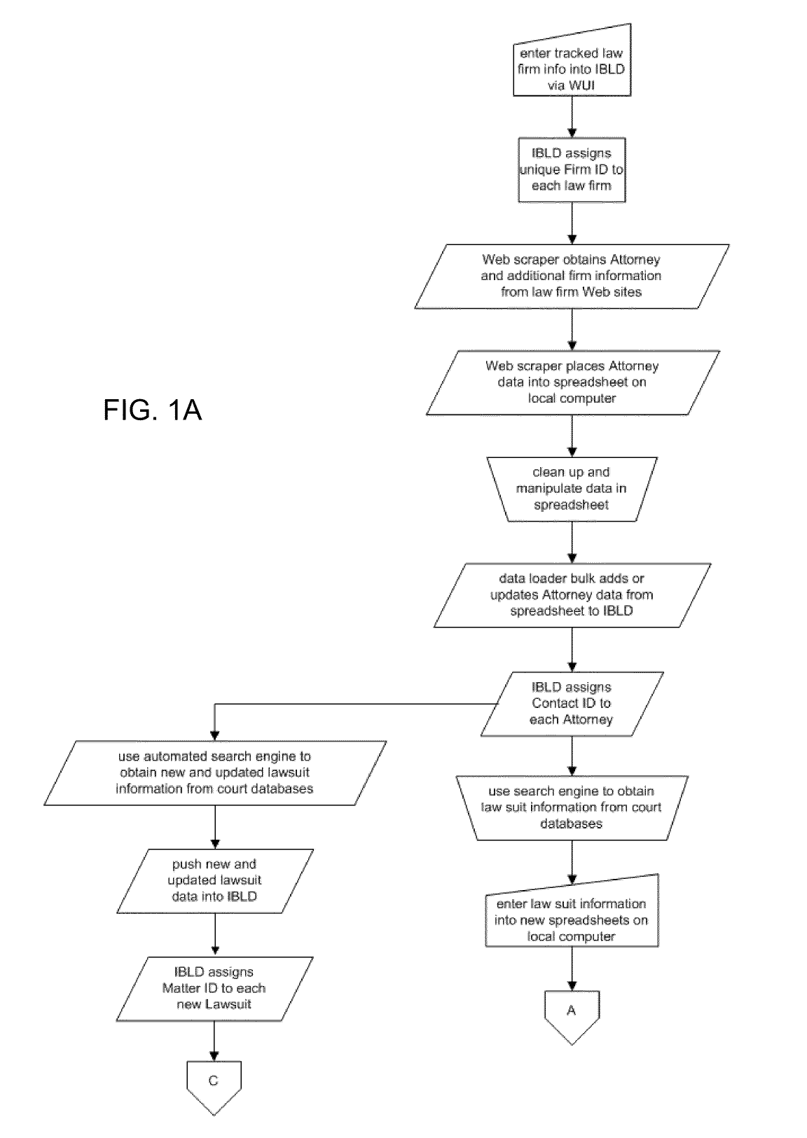

Referring now to FIGS. 1A-1D, to track Law Firms, an IBLD Administrator uses a local computer to enter data about each tracked Law Firm into a WUI. The information includes information such as the name, address, telephone number, fax number, web site uniform resource locator (“URL”), number of attorneys, and number of lawsuits for each Law Firm. The information is conventionally transmitted over the Internet directly into the IBLD or transmitted via the data loader. The IBLD assigns a unique alphanumeric identification number to each Law Firm (“Firm ID”).

To track Attorneys, the IBLD uses a Web scraper to obtain from remote Law Firm web sites over the Internet data about each Attorney listed on each Law Firm's web site, including: address, telephone number, fax number, email address, law school and year of graduation, department/specialization, and the URL of his or her biography on his or her Law Firm web site.

The web scraper places the Attorney data into a comma separated value (“CSV”) spreadsheet on a local computer. An Administrator or Researcher of the IBLD Proprietor cleans up and manipulates the data manually using a spreadsheet application program on the local computer. Via an Internet connection, the Attorney data in the CSV spreadsheet is bulk added or updated from the CSV spreadsheet into the IBLD using a data loader. The IBLD assigns a unique alphanumeric identification number (the “Contact ID”) to each Attorney.

An IBLD Researcher and/or a computer-implemented automated search tools (“CAST”) searches online court databases (e.g., PACER) for specific Lawsuits. The limiting parameters for Lawsuits that are in federal courts are those involving specific tracked Law Firms with specific Nature of Suit (“NOS”) codes. For Lawsuits filed in federal courts, there are two limiting parameters, NOS and law firm. Lawsuits filed in state courts and International Trade Commission (“ITC”) hearings do not necessarily have NOS codes like Federal Lawsuits. Accordingly, for Lawsuits filed in state courts or with the ITC, either law firm or involvement of a Global 3000 party is used as the limiting parameter. The information obtained from the online court databases by the Researcher and/or the CAST includes:

a. Lawsuit name,

b. docket number,

c. court,

d. NOS code,

e. the date the Lawsuit was filed,

f. provisional status (whether or not the case is active) and

g. Judge name (CAST only).

The target Lawsuit data gathered from the remote online court databases is displayed on a computer display device. An IBLD Administrator creates at least one CSV spreadsheet (“Case Spreadsheet”) on a local computer, one for each Law Firm, copies the displayed target Lawsuit data, and pastes it into the Case Spreadsheets.

The same Lawsuit may show up on more than one Case Spreadsheet, if it involves more than on Law Firm. For example, if there is a Lawsuit ABC v. DEF and Law Firm One represents ABC and Firm Two represents DEF, the Lawsuit will be included in two separate Case Spreadsheets, once in the Case Spreadsheet for Firm One and once in the Case Spreadsheet for Firm Two, if Firm One and Firm Two are both Law Firms tracked by the IBLD. If only one of the Law Firms is tracked by the IBLD, only one instance of the Lawsuit will show up, associated with the Case Spreadsheet for the tracked Law Firm. If none of the parties to the Lawsuit is represented by a Law Firm tracked by the IBLD, then the Lawsuit will not be input into the IBLD, even if the Lawsuit meets other criteria that would make it a target Lawsuit (such as proper NOS code).

Once the Target Lawsuit data has been entered into the Case Spreadsheet(s), IBLD Researchers and/or the CAST research remote court databases via the Internet to view online dockets of each of the Lawsuits listed in the Case Spreadsheet. The additional information obtained by the Researcher and/or CAST includes:

a. names of all Attorneys from the Law Firm listed as counsel of record,

b. the Attorneys' email addresses,

c. updated Lawsuit status,

d. judge name,

e. the name and designation of the party the Law Firm represents (for example, “Defendant: DEF”),

f. notes on the Lawsuit, and

g. dates including:
i. Close of Discovery date
ii. Initial Conference date
iii. Claim Construction/Markman date
iv. Motions (Non-Dispositive) date
v. Summary Judgment/Motion to Dismiss date
vi. Class Certification date
vii. Pre-Trial Conference date
viii. ADR (Mediation/Arbitration) date
ix. Trial Date
x. Settlement Conference date
xi. Appealed date
xii. Expert Reports due date
xiii. Closed/Terminated (date the Lawsuit is closed or the Law Firm or its client is terminated)

The additional target Lawsuit data gathered from the remote online court databases is displayed on a computer display device. The IBLD Researcher and/or CAST copies the displayed additional data and pastes it into the Case Spreadsheet on a local computer. The Case Spreadsheet has one column for each of the above data categories c-g and twelve sets of columns for each of the data categories “a” and “b.”

Using a data loader, an IBLD Administrator downloads onto a local computer from the IBLD remote server the email address and Contact ID for all Attorneys in the IBLD. The data loader places the email address and Contact ID data into two corresponding columns of the Case Spreadsheet on the local computer. Then, using the VLOOKUP function in the spreadsheet program, the IBLD Administrator associates the Contact ID number with each Attorney listed as counsel on individual Lawsuits contained in the Case Spreadsheets.

An IBLD Administrator manually adds to each Lawsuit in the Case Spreadsheets on the local computer the Firm ID number for the respective firm.

An IBLD Administrator adds the Lawsuits to the IBLD by uploading them in bulk over the Internet from the local computer using a data loader. The following Lawsuit data is loaded:

a. Firm ID,

b. Contact IDs for Attorneys associated with the Law Firm and particular Lawsuit,

c. updated status,

d. judge name,

e. the name and designation of the party the Law Firm represents (for example, “Defendant: DEF”),

f. notes on the Lawsuit, and

g. dates including:
i. Close of Discovery date
ii. Initial Conference date
iii. Claim Construction/Markman date
iv. Motions (Non-Dispositive) date
v. Summary Judgment/Motion to Dismiss date
vi. Class Certification date
vii. Pre-Trial Conference date
viii. ADR (Mediation/Arbitration) date
ix. Trial Date
x. Settlement Conference date
xi. Appealed date
xii. Expert Reports due date
xiii. Closed/Terminated (date the Lawsuit is closed or the Law Firm or its client is terminated)

The IBLD assigns a unique alphanumeric identification number (“Matter ID”) to each Lawsuit and generates a new CSV spreadsheet containing both the Lawsuit name and Matter ID.

An IBLD Administrator copies the column containing the Matter ID from the new CSV spreadsheet containing both the Lawsuit name and Matter ID and pastes it into the Case Spreadsheet on the local computer. The IBLD Administrator then adds the Attorney data in bulk from the local computer to the Lawsuits in the IBLD, using the data loader. Only one Attorney per Lawsuit can be bulk added during any one bulk transfer. Accordingly, this procedure is run a total of twelve times in order to capture all of the potential Attorneys.

As an alternative to obtaining the additional target Lawsuit data from court databases and transferring it and manipulating it using the data loader and Case spreadsheet, the IBLD Administrator can use the data loader to upload in bulk over the Internet the following Lawsuit data from the local computer to the IBLD:

a. Lawsuit name,

b. docket number,

c. court,

d. NOS code,

e. the date the Lawsuit was filed,

f. provisional status (whether or not the Lawsuit is active) and

g. Firm ID.

The data loader pushes the “bare bones” Lawsuit data from the court database into the IBLD. Following the bulk upload, either an IBLD Researcher and/or CAST locates the Lawsuit using the WUI; or the bare bones data is exported from the IBLD to the Researcher's local computer and/or to the CAST. In the instance where an IBLD Researcher and/or CAST locates the Lawsuit using the WUI, the WUI includes editable fields, through which the Researcher updates and adds the following Lawsuit data directly in the IBLD over the Internet:

a. updated status,

b. judge name,

c. the name and designation of the party the law,

d. notes on the Lawsuit, and

e. dates including:
i. Close of Discovery date
ii. Initial Conference date
iii. Claim Construction/Markman date
iv. Motions (Non-Dispositive) date
v. Summary Judgment/Motion to Dismiss date
vi. Class Certification date
vii. Pre-Trial Conference date
viii. ADR (Mediation/Arbitration) date
ix. Trial Date
x. Settlement Conference date
xi. Appealed date

xii. Expert Reports due date
xiii. Closed/Terminated (date the Lawsuit is closed or the Law Firm or its client is terminated)

In the instance where the bare bones data is exported from the IBLD to the Researcher's local computer, the data is exported in the form of a CSV spreadsheet.

For each G3K company, an IBLD Researcher, with or without the use of the Web scraper, obtains from independent web sites (that is, web sites that are not associated with the IBLD Proprietor) the following G3K company data:

a. company name,

b. revenue in billions of dollars,

c. details regarding legal department personnel,

d. company URL

e. country of origin, and

f. the company's industry.

The G3K company data gathered from the independent web sites is displayed on a computer display device. The IBLD Researcher or Web scraper creates a new CSV spreadsheet on a local computer, copies the displayed G3K company data, and pastes it into the new CSV spreadsheet.

An IBLD Administrator adds the G3K company data to the IBLD in bulk using the data loader, creating an online database of information regarding the G3K companies. The IBLD assigns a unique alpha-numeric identification number (“Party ID”) to each G3K company.

Once the Lawsuit data is loaded into the IBLD, an IBLD Administrator creates a new CSV spreadsheet (“Outside Litigation Counsel Spreadsheet”) in a local computer to receive Outside Litigation Counsel data. The Administrator uses the data loader to export from the IBLD to the Outside Litigation Counsel Spreadsheet the following data regarding every Lawsuit:

a. Matter ID

b. Representing (which litigant(s) the law firm/attorneys represent)

c. Party ID

d. Party name

On the Outside Litigation Counsel Spreadsheet, the IBLD Administrator uses functions of the spreadsheet program in the order listed to:

a. separate every word in the Representing field,

b. in separate sets of columns, re-combining the words in groups of two three and four,

c. using a function (such as the VLOOKUP function in MS Excel®) that allows the user to quickly look up a field value for a certain record, searching for matches in names of the G3K companies to the sets of single, double, triple and quadruple words from the Representing fields,

d. when such matches exist, returning the Party ID number in designated fields,

e. removing duplicate Party ID numbers in any one row using a series of IF THEN statements, and

f. performing a series of copy and paste functions to ensure that each row contains only one Party ID number, creating new rows for each Matter containing multiple associated Party ID numbers.

This procedure on the local computer will associate on the Outside Litigation Counsel Spreadsheet all of the Party IDs for G3K companies associated with Lawsuits where they are represented by Law Firms tracked by the IBLD.

An IBLD Administrator uses the data loader to update in bulk over the Internet to the IBLD the G3K companies associated with Lawsuits where they are represented by Law Firms tracked by the IBLD.

The IBLD Administrator then creates a new CSV spreadsheet (“Global 3000 Matter Spreadsheet”) on a local computer and uses the data loader to export from the IBLD to the Party Spreadsheet the following data regarding every Lawsuit:

a. Matter ID

b. Lawsuit name and represented party names combined (“NRCU”)

c. Party ID

d. Party name

On the Party Spreadsheet, the IBLD Administrator uses functions of the spreadsheet program in the order listed to:

a. separate every word in the NRCU field,

b. in separate sets of columns re-combining the words in groups of two three and four,

c. using a field value lookup function, searching for matches in names of the G3K companies to the sets of single, double, triple and quadruple words from the representing fields,

d. when such matches exist, returning the Party ID number in designated fields,

e. removing duplicate Party ID numbers in any one row using a series of IF THEN statements, and

f. performing a series of copy and paste functions to ensure that each row contains only one Party ID number, creating new rows for each Matter containing multiple associated Party ID numbers.

This procedure on the local computer will associate on the Global 3000 Matter Spreadsheet all of the Party IDs for G3K companies associated with Lawsuits where they are a party to a Lawsuit where at least one Law Firm tracked by the IBLD is counsel.

An IBLD Administrator uses the data loader to update in bulk over the Internet to the IBLD the G3K companies associated with Lawsuits where they are a party to a Lawsuit where at least one Law Firm tracked by the IBLD is counsel.

Information in the IBLD is interlinked. Attorneys are associated with Law Firms and with Lawsuits. Law Firms are associated with Attorneys and Lawsuits. Lawsuits are associated with Law Firms, Attorneys, and the G3K companies that are parties (“G3K parties”). Also, all of the data regarding all of the Attorneys, Law Firms, Lawsuits, and G3K parties are Boolean searchable using a search tool in the WUI.

Because all of the data in the IBLD is interlinked and searchable, a User associated with an IBLD Subscriber (“IBLD User” or “User”) can create and save reports that select data fields and add criteria from any number of the Attorneys, Law Firms, Lawsuits and G3K parties. The reports can also include charts and graphs that visually represent the data contained in the report. For example, a User can create and save a report that shows which Lawsuits involve which Attorneys from which Law Firms where a specific G3K company is involved and the Lawsuit has particular dates and the Nature of Suit is a particular type. There are virtually limitless combinations of reports that a User can create and save. Users can also export the results of reports into a spreadsheet on their local computer.

Once the IBLD has been set up, the CAST uses a search engine to obtain new and updated Lawsuit information and enter it into the IBLD. Cases that are not closed or terminated are researched for any updated or additional information, by an IBLD Administrator and/or Researcher and/or by the CAST, as described above.

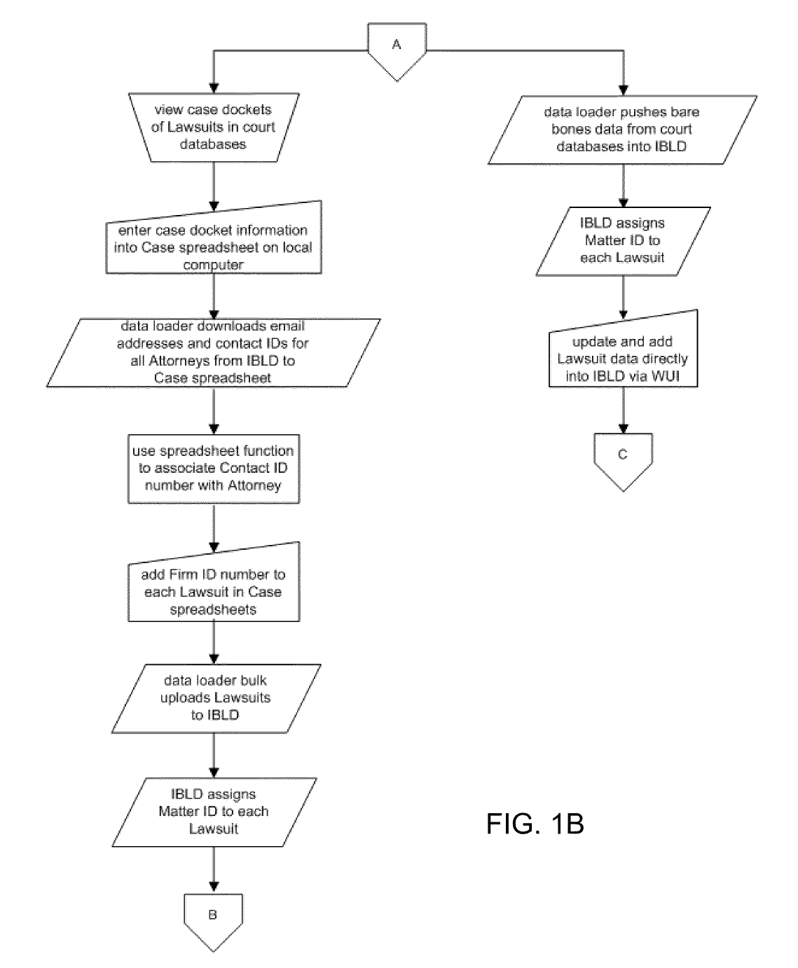

The method by which Users access and use the IBLD will now be described. Once the IBLD has been created, Users can access the IBLD via a local WUI to research cases that are at a variety of stages in the litigation process, such as cases which are new, in discovery, in motions, or going to trial at major law firms. As discussed in greater detail hereinafter, the User can drill down to discover his or her ideal LMI. Initially, the User navigates to a Web page (FIG. 2) that allows him or her to log on securely to the LMI system's Web-based user interface.

The Subscriber WUI provides a variety of functions, accessible through corresponding tabs conventionally arranged above a frame. As shown in FIGS. 2, 3, 4, 5, 6, and 7, these tabs include a Home tab, a Firms tab, a Contacts tab, a Parties tab, a Matters tab, a Reports tab, and a Support tab. Additional tabs, for example a Suggestions tab and a Dashboards tab, can also be included, as shown in FIG. 9, which also shows a portion of an exemplary Dashboard page.

A permanent column on the left hand side of the WUI stays visible regardless of the tab selected by the User, except when viewing reports under the reports tab. The permanent column includes conventional sidebar and advanced search tools and a conventional, recently-viewed items list for viewing a list of recently viewed firms, matters and contacts. Search terms in the sidebar search are automatically treated as a phrase in quotes and are limited to only a certain subset of fields. Search terms in the advanced search are treated as separate words and are searched in fields selectable by the User.

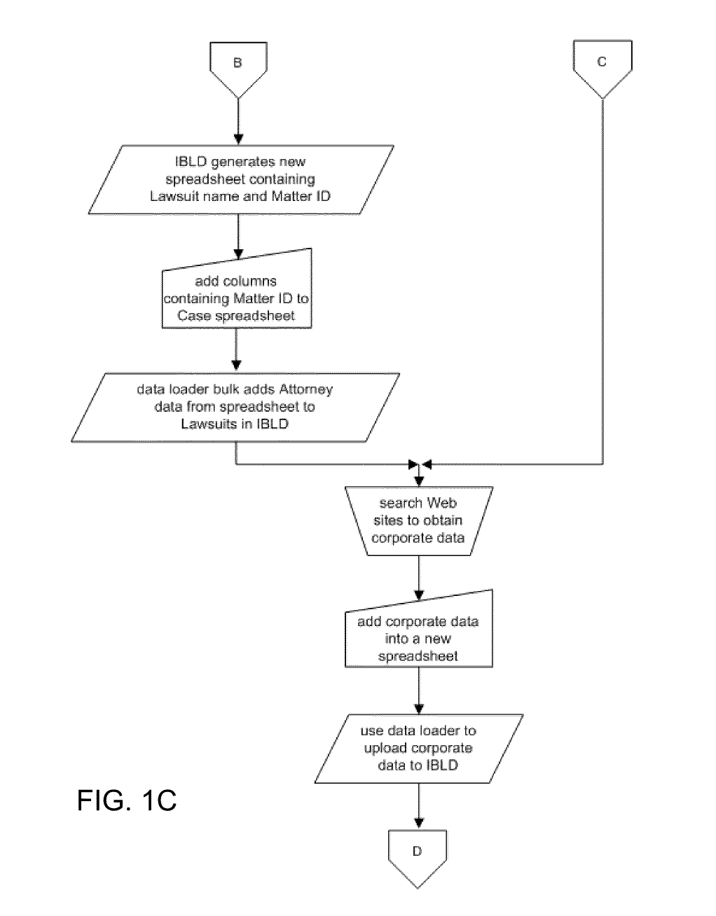

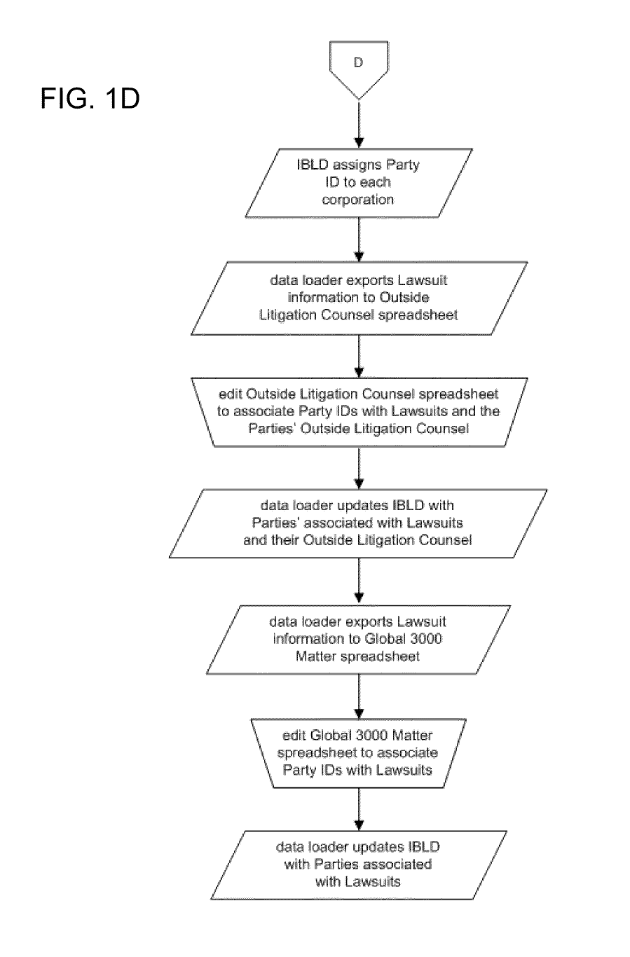

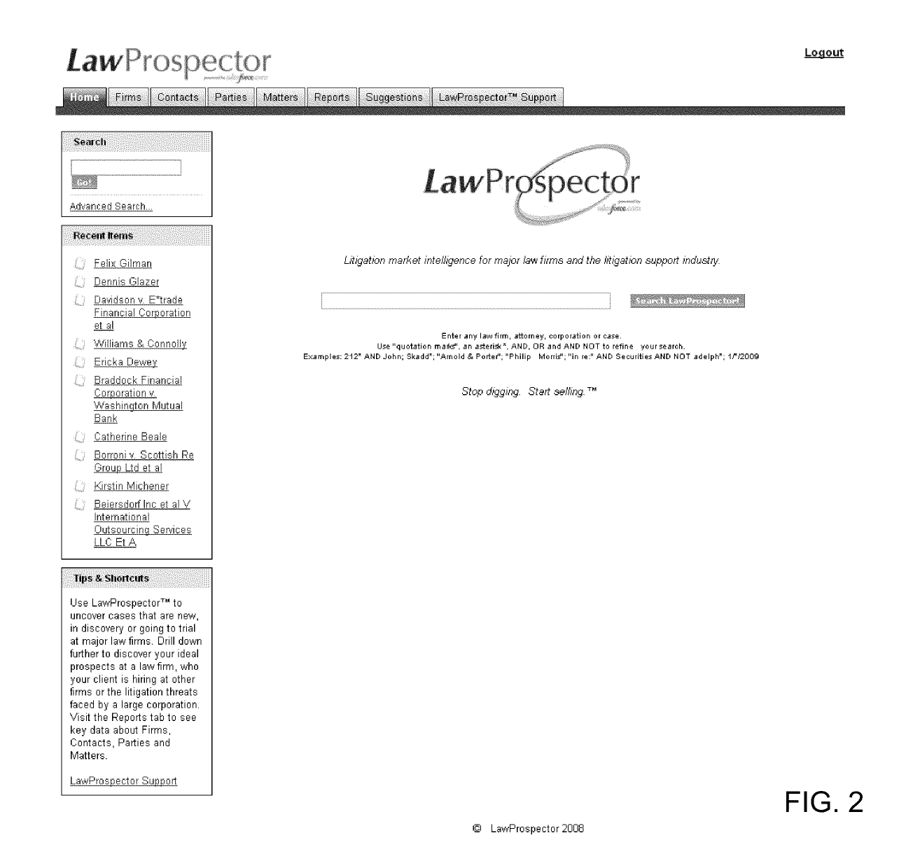

The Firms tab (FIG. 3) provides the User with access to all Firm information in the IBLD, including law firms' contact information, attorneys, and matters, via a drop-down Firms View menu (FIG. 3A) and a Firms view section. The drop-down Firms View menu allows the User to scroll-down and select different ways to sort and view the Subscriber's accounts in the Firms view section, including: All Firms, My Firms, New Firms Last Week, New Firms This week, or Recently Viewed Firms. For each selection in the drop-down Firms View menu, the Firms view section has its own drop-down menu (FIG. 3B) allowing the User to scroll-down and select Recently Created, Recently Modified, and Recently Viewed Firms. For example, the Recently Viewed Firms view provides the User with a list of the names of most recently viewed firms and hyperlinks to their Web sites. Clicking on a law firm name pulls up related Firm Detail, Contacts, and Matters (FIG. 3C). Other features in the Firms tab include direct links to the firm web site, email links for quick emailing, and Google™ This Firm and Google™ Map Address.

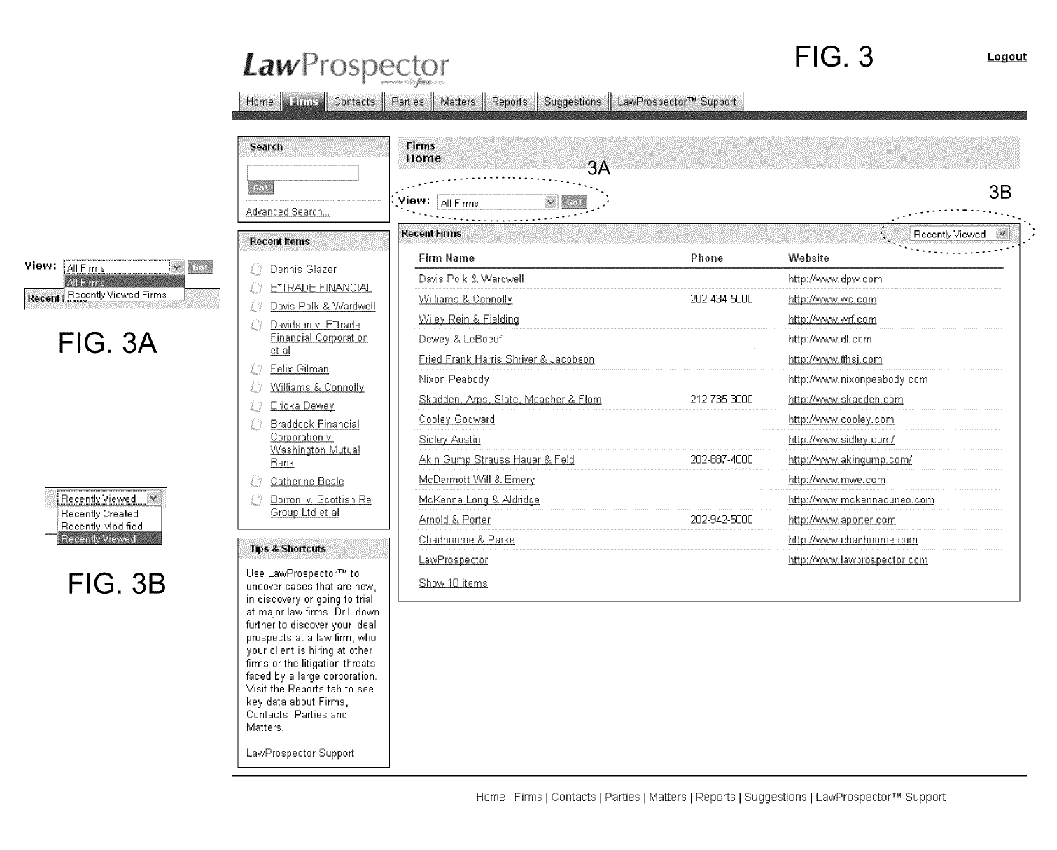

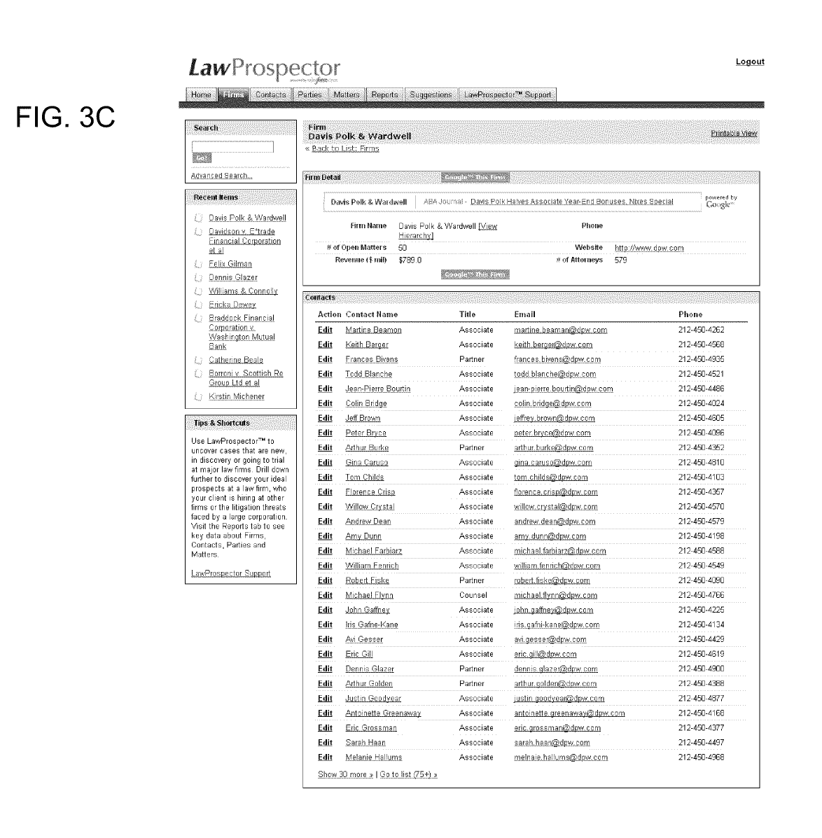

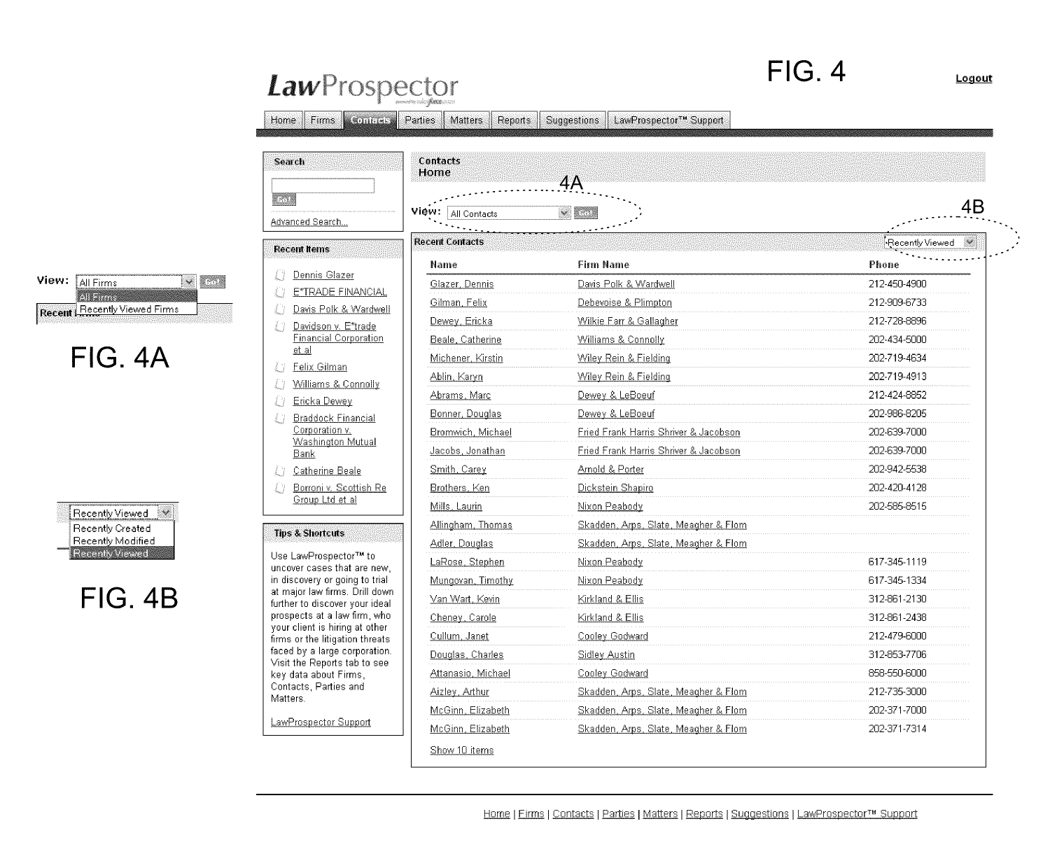

The Contact tab (FIG. 4) provides the User with access to more detailed information about a Contact in the IBLD, including attorney name, firm name, and phone number, via a drop-down Contacts View menu (FIG. 4A) and a Contacts view section. The drop-down Contacts View menu allows the User to scroll-down and select different ways to sort and view the Subscriber's Contacts information, including: All Contacts, Birthdays This Month, New Last Week, New This Week or Recently Viewed. For each selection in the drop-down Contacts View menu, the Contacts view section has its own drop-down menu (FIG. 4B) allowing the User to scroll-down and select Recently Created, Recently Modified, and Recently Viewed Firms. Clicking on an attorney name pulls up the attorney's contact information (in a Contact Detail section) and associated Matters (in a Matters section) (FIG. 4C). All Matters linked to the selected Contact will appear in the Matters section. Some of the information is locked, and cannot be changed by the User. Other categories including Link to Bio, Birthday and Assistant information are Community Created Content (that is, they are created or edited by Users); and any User can edit these fields, which can be viewed by all Subscribers. Links are also included to enable the User to search a selected Contact using a publicly-available search engine such as Google™ and to search a commercial professional networking web site, such as LinkedIn™.

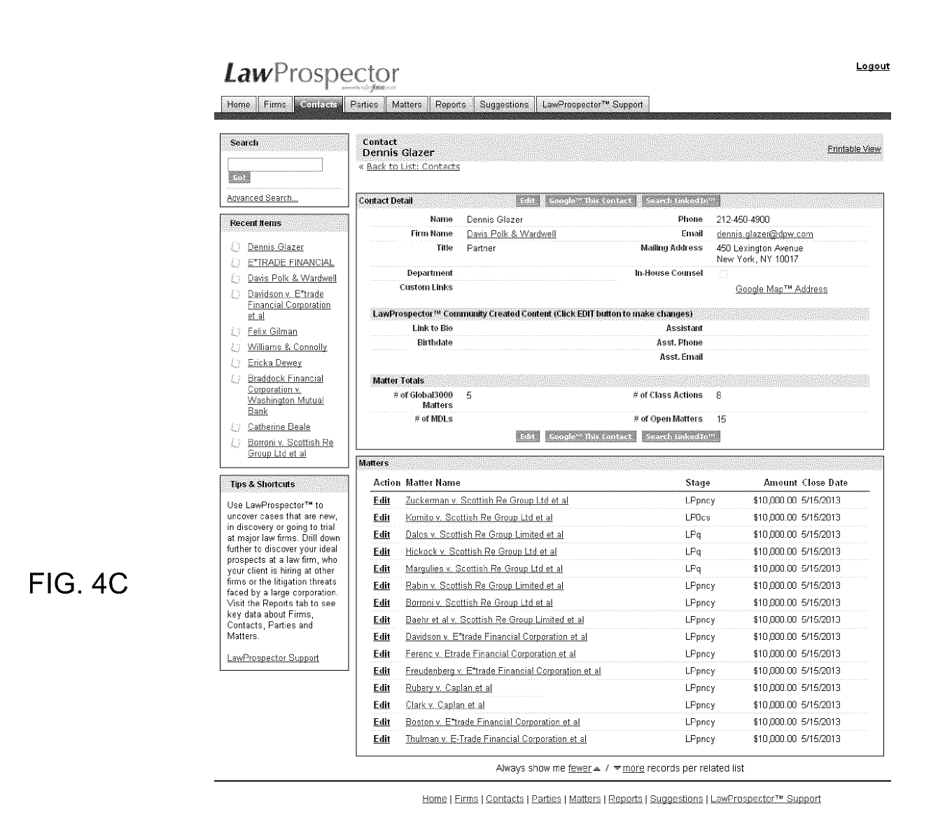

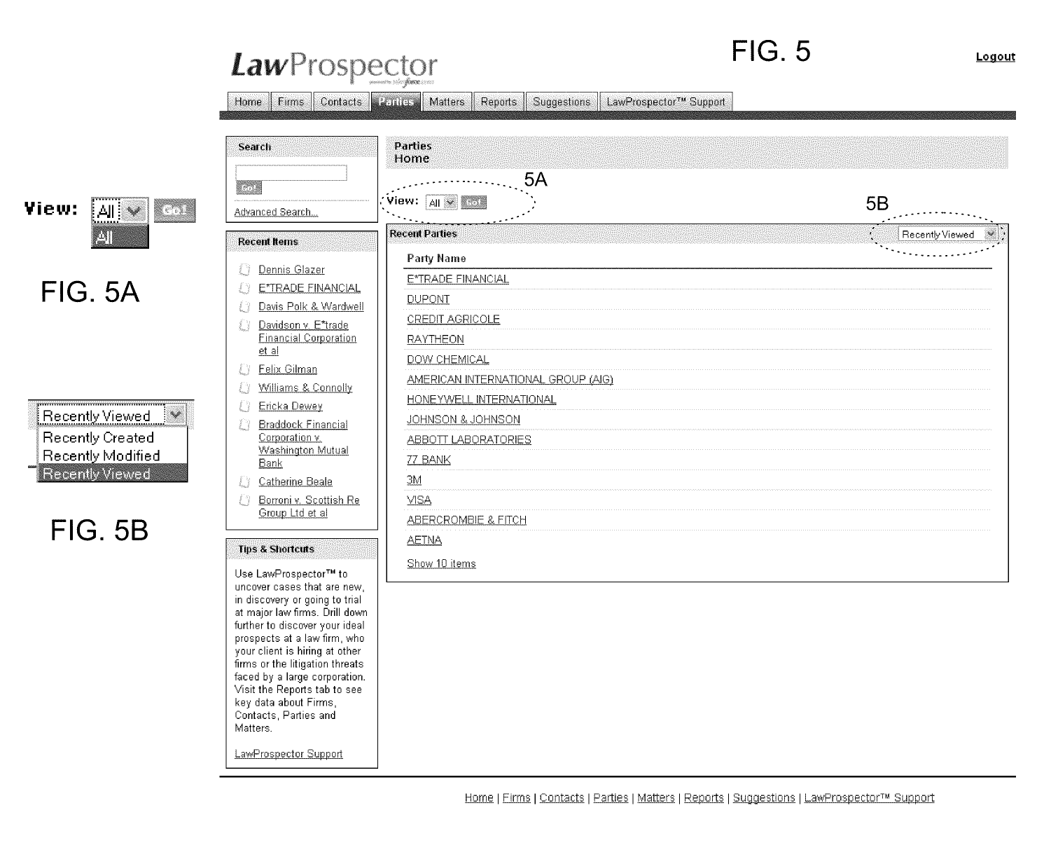

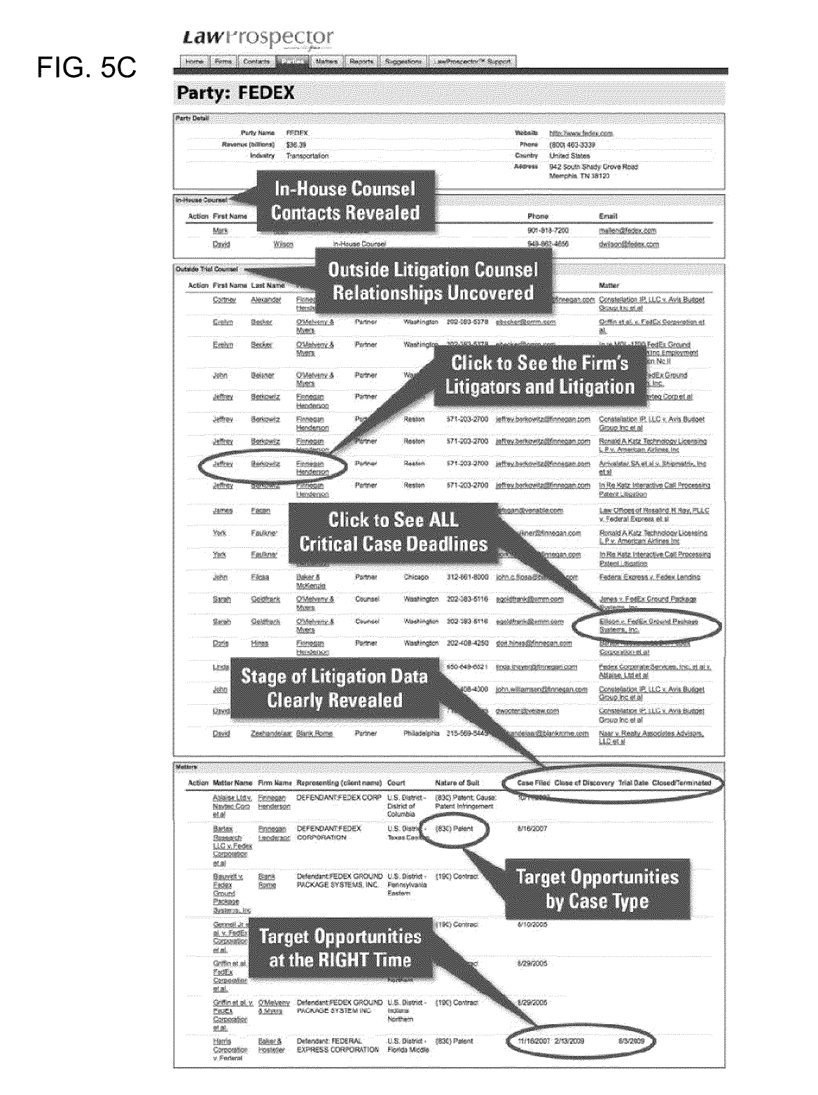

The Parties tab (FIG. 5) provides the User with a list of significant corporations in the IBLD, and the cases in which they are involved, and information about the corporation such as name, country, revenue, industry, address, website, telephone number, a list of in-house counsel names and contact information, a list of outside litigation counsel and their associated Lawsuits and a list of all Lawsuits involving that Party., via a drop-down Parties View menu (FIG. 5A) and a Party view section. The drop-down Parties View menu allows the User to scroll-down and select different ways to sort and view the Subscriber's Parties information, including, but not limited to: View All. When the User initially navigates to the Parties page, it displays the Parties most recently viewed by the User. A Go! button causes the Parties view section to display a full list of the Parties sorted alphabetically. For each selection in the drop-down Parties View menu, the Parties view section has its own drop-down menu (FIG. 5B) allowing the User to scroll-down and select Recently Created, Recently Modified, and Recently Viewed Parties.

Within any Party view displayed in the Parties view section, the User can access a list of matters in which a Party is involved, a list of in-house counsel, and a list of outside counsel, by clicking on a hyperlink associated with Party's name (FIG. 5C). Clicking on a hyperlink associated with any Matter brings the User directly to the Matter's page. As also shown in FIG. 5C, clicking on hyperlinks associated with other information in the lists brings the User additional related information, including (but not limited to) litigators and litigation for outside counsels' Firms, critical case deadlines, stage of litigation.

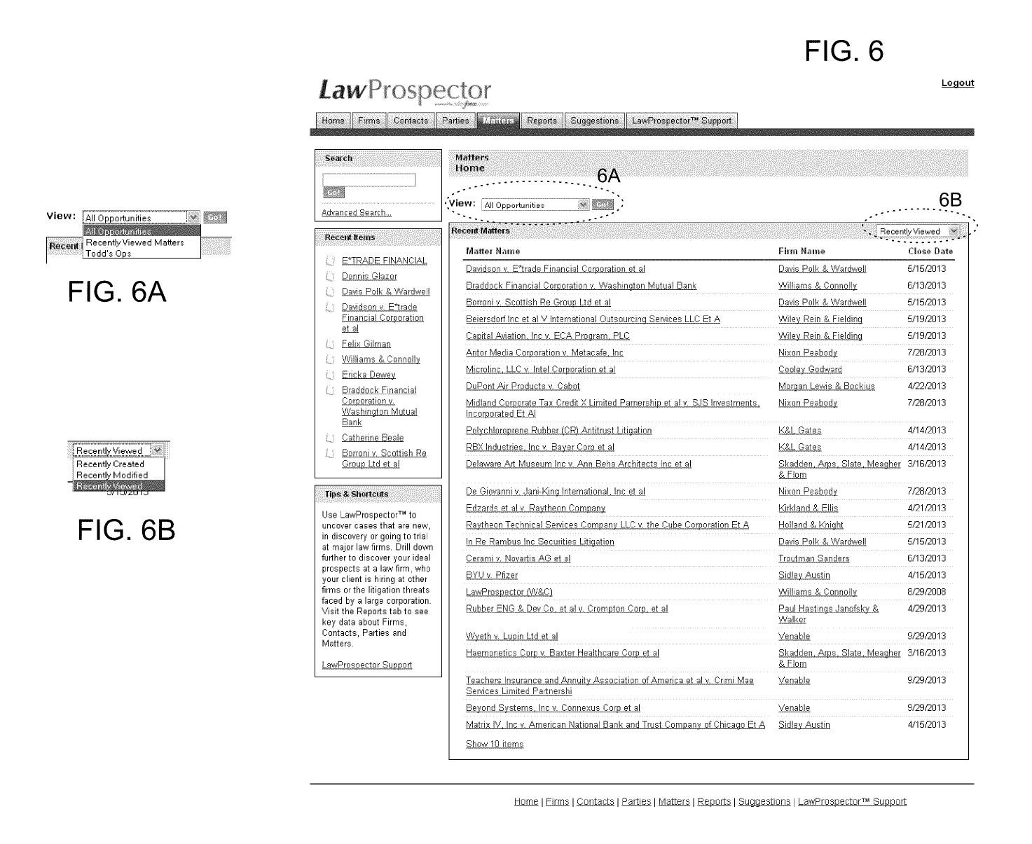

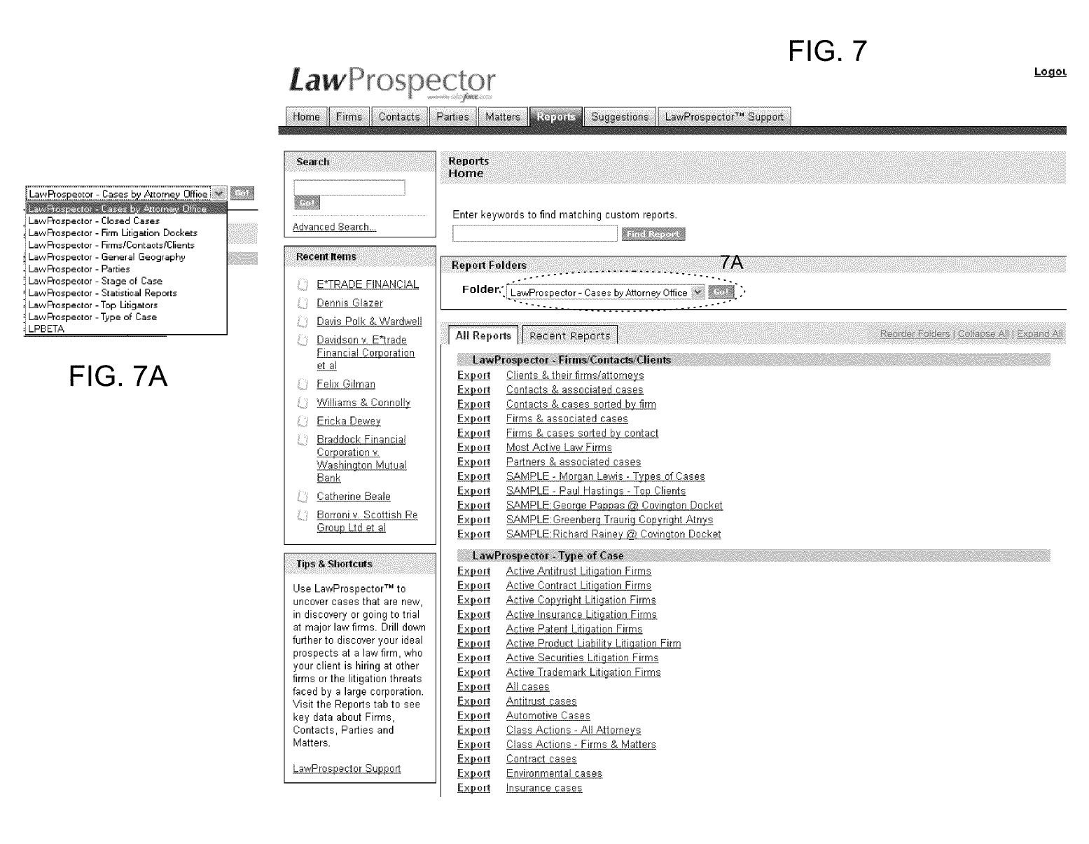

The Matters tab (FIG. 6) allows the User to view key data in the IBLD regarding cases in litigation, mediation and arbitration, via a drop-down View menu (FIGURE 6A) and a Matters view section. The drop-down Matters View menu allows the User to scroll-down and select different ways to sort and view the Subscriber's Matters information, including:

All Opportunities, Recently Viewed Matters, and [User's name] Opportunities. When the User initially navigates to the Matters page, it displays the Matters most recently viewed by the User. For each selection in the drop-down Matters View menu, the Matters view section has its own drop-down menu (FIG. 6B) allowing the User to scroll-down and select Recently Created, Recently Modified, and Recently Viewed Matters.

Within any of the Matters views, the User can access a page with more detailed information about a Matter by clicking a hyperlink associated with the Matter. The individual Matters pages contain information including, but not limited to: substantive matter data, key dates, and firms/contacts. Links are also included to enable the User to search a selected Matter using a publicly-available search engine such as Google™ and to search a commercial court database such as Pacer Lookup.

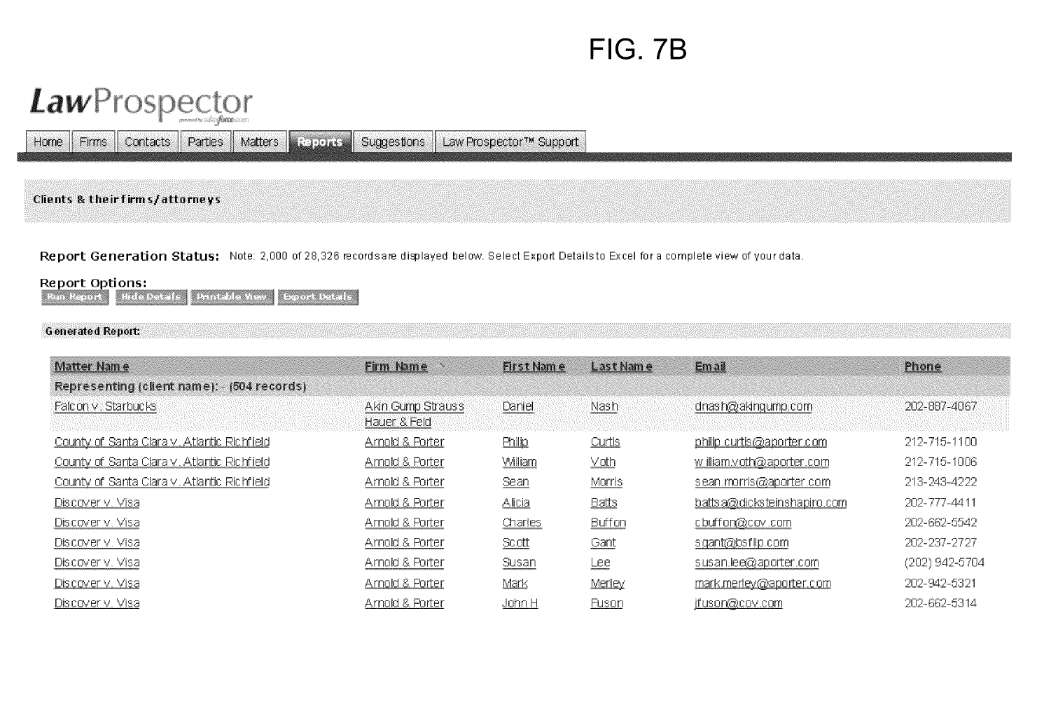

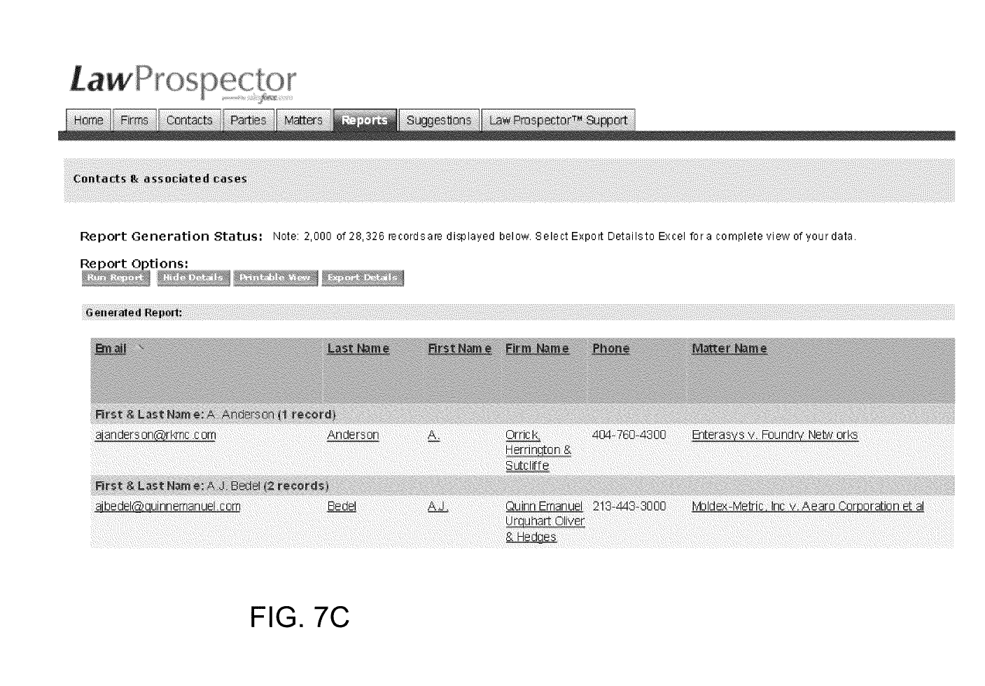

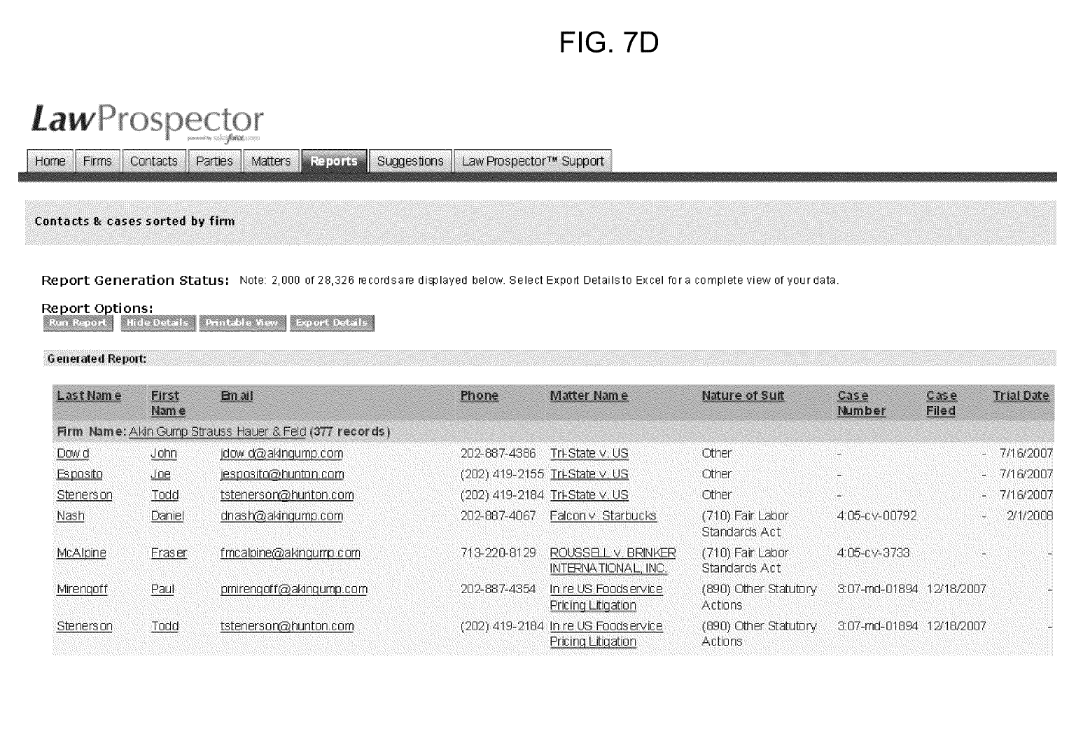

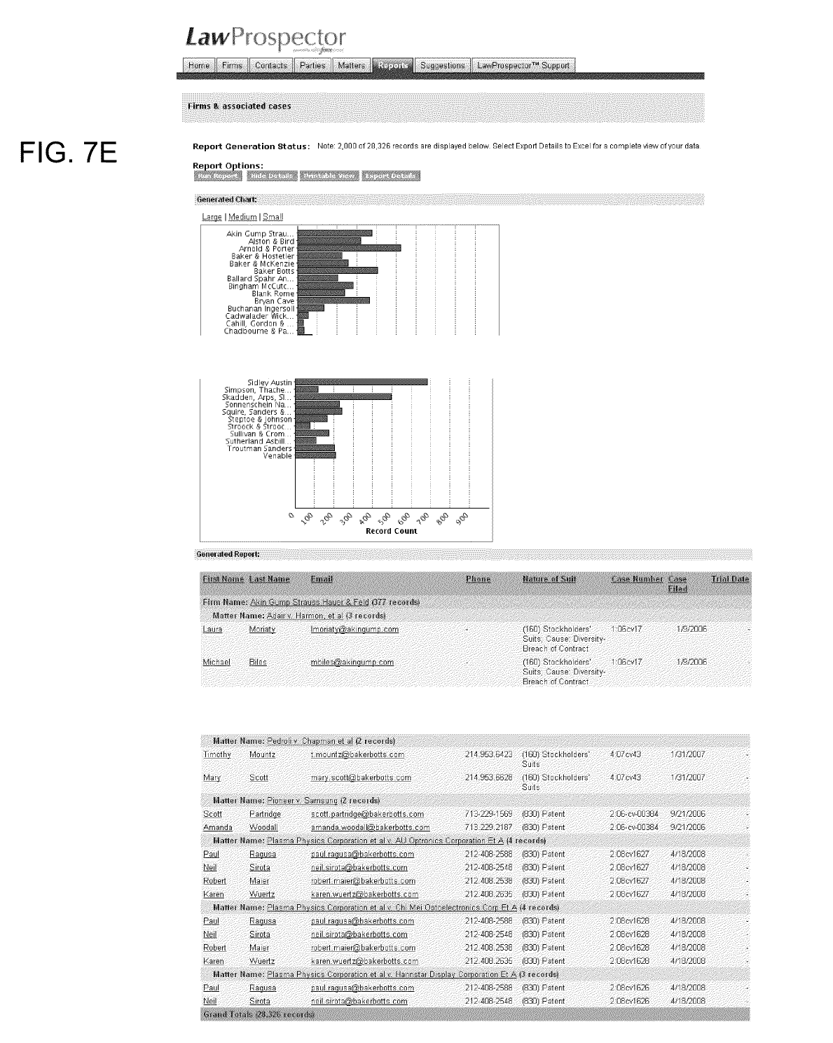

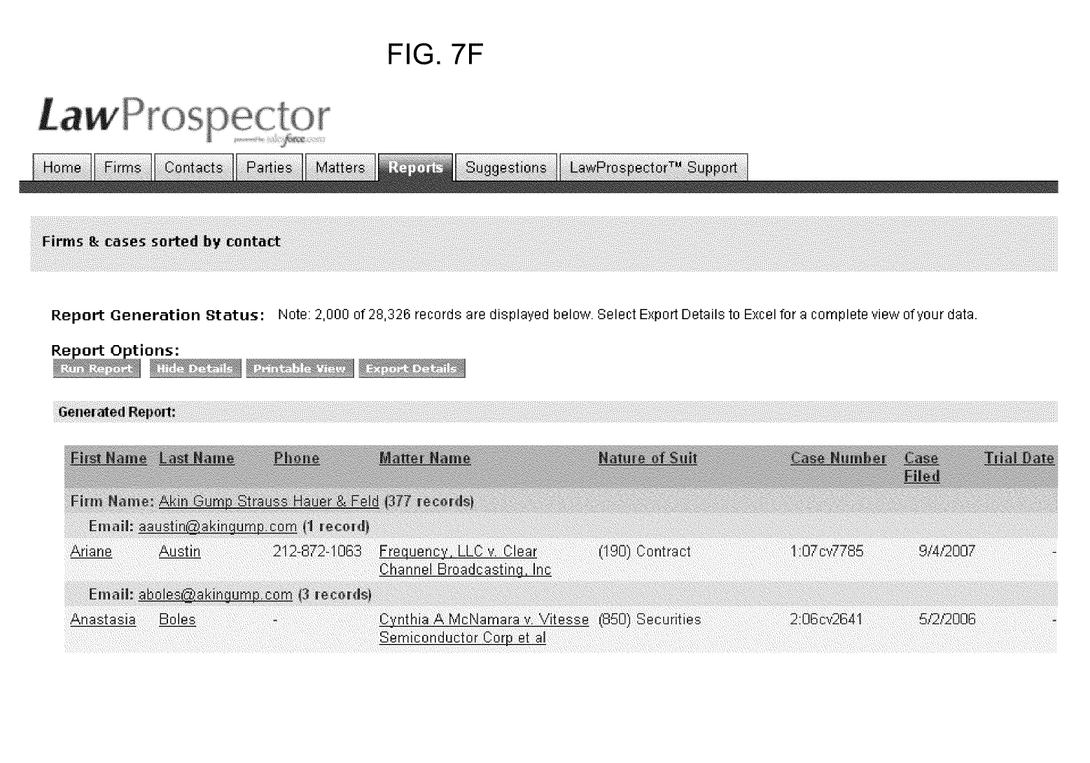

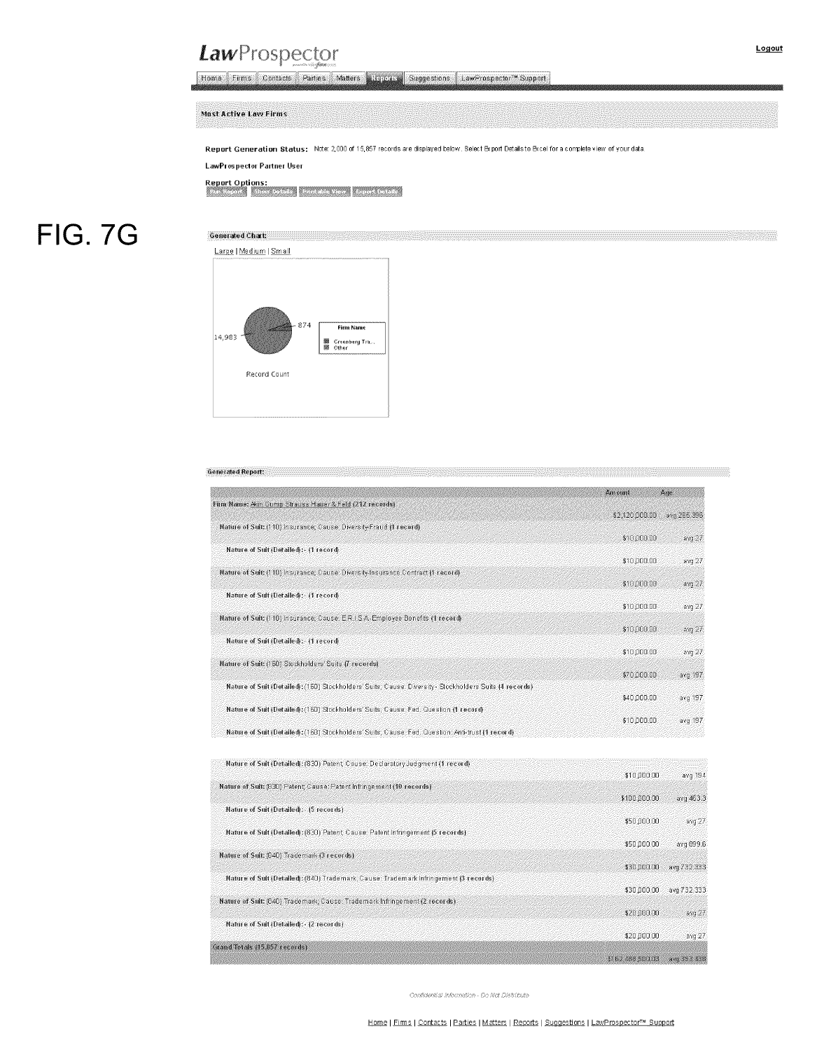

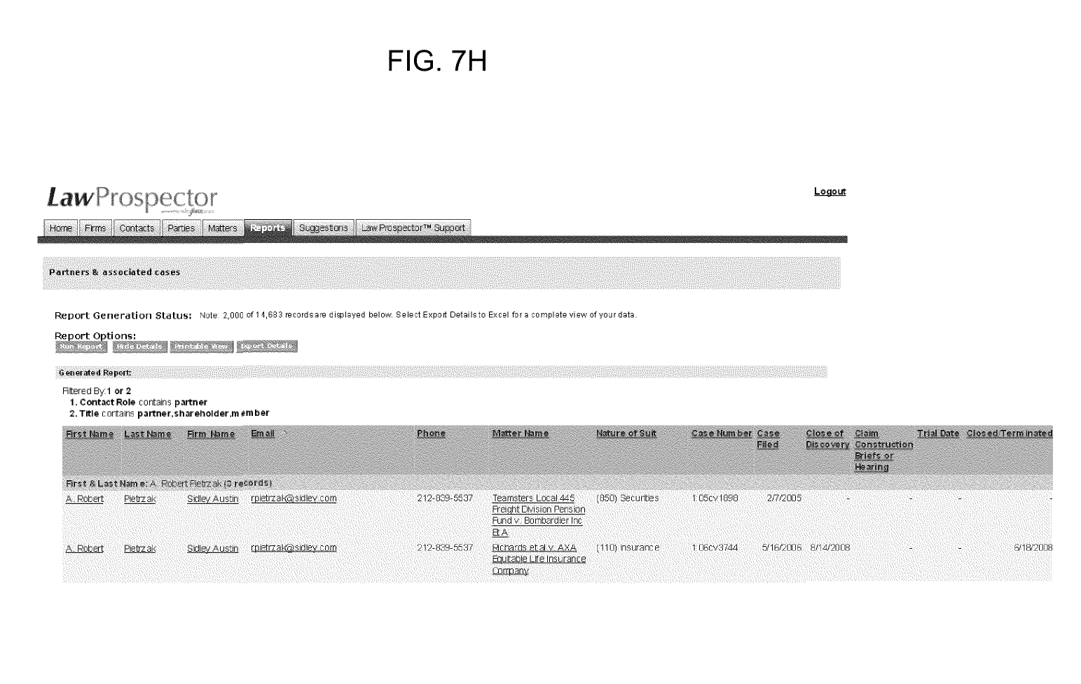

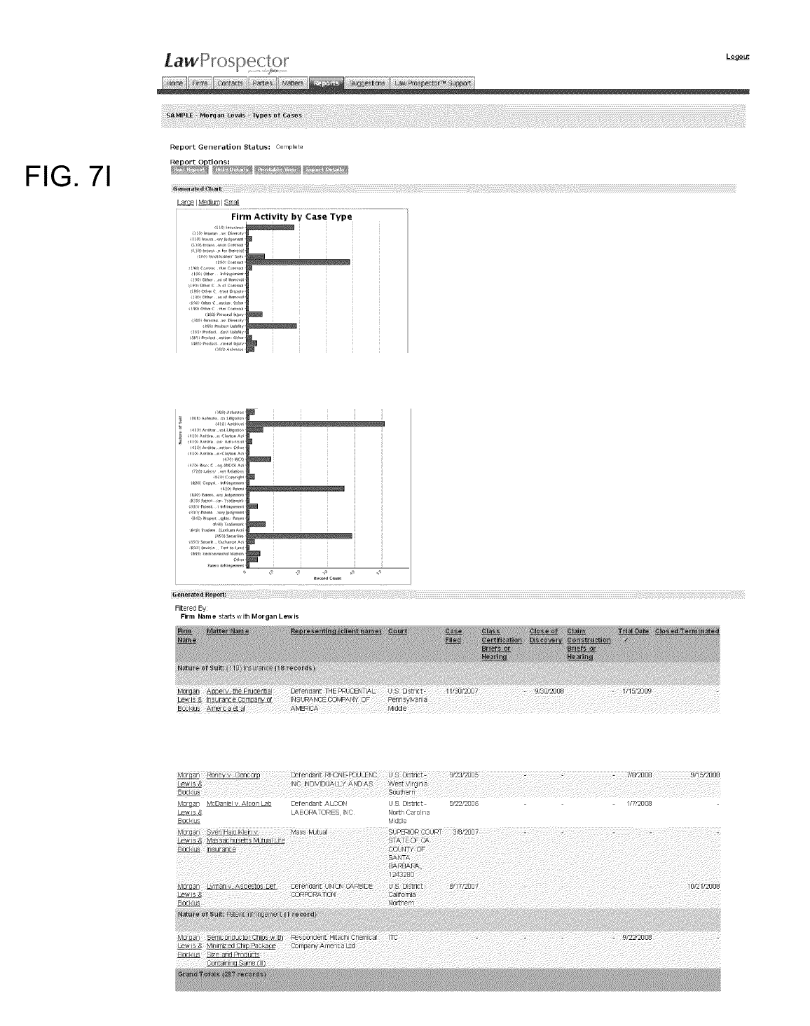

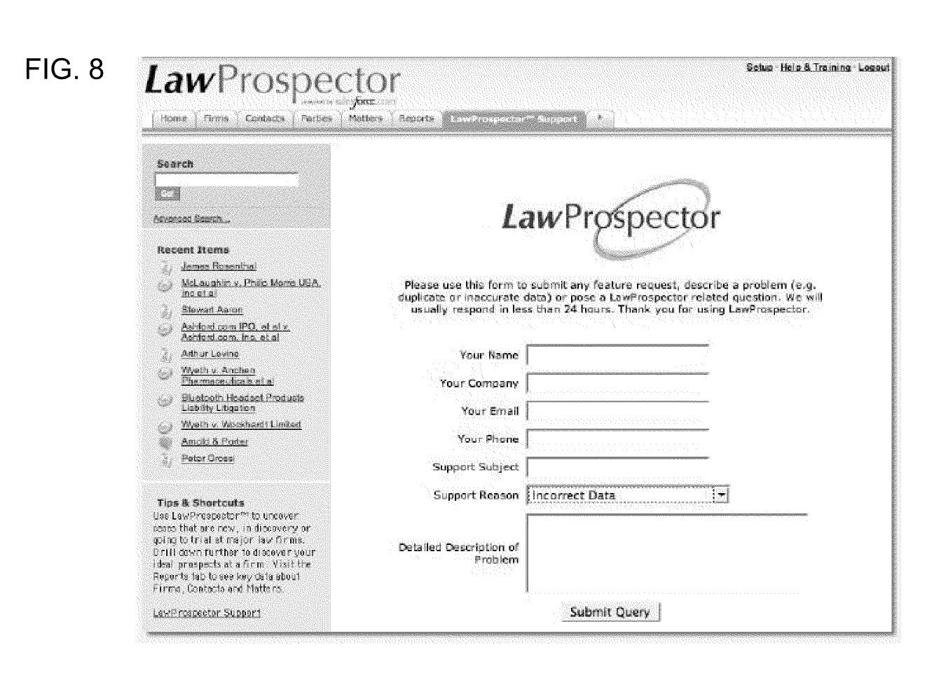

The Reports tab (FIG. 7) allows Users to see key data available in their subscriptions; and also allows Users to run standard reports or create customized ones to gain insight into his or her target firms and contacts and their matters in the IBLD, via a drop-down Report Folders menu (FIG. 7A) and a Reports view section. The drop-down Report Folders menu allows the User to scroll-down and select different ways to sort and view the Subscriber's Matters information, including, but not limited to: Cases by Attorney Office, Closed Cases, Firm Litigation Dockets, Firms/Contacts/Clients, General Geography, Parties, Stage of Case, Statistical Reports, Top Litigators, and Type of Case. When the User initially navigates to the Reports page, it displays a list of the standard Reports types, including: Firms/Contacts/Clients, General Geography, Industries & Issues, Cases by Attorney Locale, Firm Litigation Docket, Type of Case, Stage of Case, and Closed Cases. Clicking on a hyperlink associated with each Reports type toggles the expansion and contraction of an associated menu. For example, Type of Case is associated with menu items including (but not limited to): All cases, Antitrust cases, Contract cases, Environmental cases, Insurance cases, Patent cases, Product liability cases, Securities cases, and Stockholder cases.

If the User selects Contract cases from the Type of Case menu, a page is displayed listing all Contract cases in the IBLD. Individual reports compile data, allowing the Subscriber's sales team to target specific types of cases at specific stages in the litigation handled by specific attorneys or law firms. For example, the reports can show the User all of the matter, firm, and contact information for specific types of cases—all of which can be sorted by any field in the report. Examples of different Reports are shown in FIGS. 7B-7I.

The Support tab (FIG. 8) provides the User with a form for submitting a feature request, describing a problem, or posing a question related to the IBLD service, any time of day or night.

Other Implementation Details

1. Terms

The detailed description contained herein is represented partly in terms of processes and symbolic representations of operations by a conventional computer. The processes and operations performed by the computer include the manipulation of signals by a processor and the maintenance of these signals within data packets and data structures resident in one or more media within memory storage devices. Generally, a “data structure” is an organizational scheme applied to data or an object so that specific operations can be performed upon that data or modules of data so that specific relationships are established between organized parts of the data structure.

A “data packet” is a type of data structure having one or more related fields, which are collectively defined as a unit of information transmitted from one device or program module to another. Thus, the symbolic representations of operations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as issuing, sending, altering, adding, disabling, determining, comparing, reporting, and the like, which are often associated with manual operations performed by a human operator. The operations described herein are machine operations performed in conjunction with various inputs provided by a human operator or user that interacts with the computer.

2. Hardware

It should be understood that the programs, processes, methods, etc. described herein are not related or limited to any particular computer or apparatus, nor are they related or limited to any particular communication architecture. Rather, various types of general purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

3. Program

In the preferred embodiment, the steps of the present invention are embodied in machine-executable instructions. The instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components.

The foregoing system may be conveniently implemented in a program or program module(s) that is based upon the diagrams and descriptions in this specification. No particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many computers, computer languages, and operating systems which may be used in practicing the present invention and therefore no detailed computer program could be provided which would be applicable to all of these many different systems. Each user of a particular computer will be aware of the language and tools which are most useful for that user's needs and purposes.

The invention thus can be implemented by programmers of ordinary skill in the art without undue experimentation after understanding the description herein.

4. Product

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

5. Components

The major components (also interchangeably called aspects, subsystems, modules, functions, services) of the system and method of the invention, and examples of advantages they provide, are described herein with reference to the figures. For figures including process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein. However, the invention also includes any new, unconventional implementation means.

6. Web Design

Any web site aspects/implementations of the system include conventional web site development considerations known to experienced web site developers. Such considerations include content, content clearing, presentation of content, architecture, database linking, external web site linking, number of pages, overall size and storage requirements, maintainability, access speed, use of graphics, choice of metatags to facilitate hits, privacy considerations, and disclaimers.

Modifications and variations of the above-described embodiments of the present invention are possible, as appreciated by those skilled in the art in light of the above teachings. It is therefore to be understood that the invention may be practiced otherwise than as specifically described.

We claim:

1. A method for creating and maintaining an Internet-based, relational legal database for tracking and providing information regarding selected large companies, Law Firms, Attorneys and other employees employed by the Law Firms, and Lawsuits in which the Law Firms represent at least one of the selected large companies as a party, wherein the relational legal database is hosted on a server and maintained and administered by an Internet-based, relational legal database Proprietor to perform maintenance and administration of the relational legal database via a local computer having a processor, the method comprising the steps of:
loading data about each tracked Law Firm into the relational legal database;
assigning a unique Law Firm ID to each Law Firm, using the relational legal database;
obtaining from remote Law Firm web sites over the Internet Attorney data for each Attorney listed on each Law Firm's web site, using a computer program for extracting content from a Web site;
bulk adding or updating the Attorney data into the relational legal database, using a data loader;
assigning a unique Contact ID to each Attorney in the relational legal database, using the relational legal database;
obtaining Lawsuit data from remote court databases over the Internet data;
loading the Lawsuit data into the legal relational database, using a data loader;
assigning a unique Matter ID to each Lawsuit in the legal relational database, using the relational legal database;
obtaining from independent web sites over the Internet Company data for each selected large company;
loading the Company data into the relational legal database, using a data loader;
assigning a unique Party ID to each selected large company in the relational legal database, using the relational legal database;
associating all of the Party IDs for the selected large companies associated with Lawsuits where they are represented by Law Firms tracked by the relational legal database;
updating in bulk over the Internet to the relational legal database the selected large companies associated with Lawsuits where they are represented by Law Firms tracked by the relational legal database, using a data loader;
associating the Party IDs for the selected large companies associated with tracked Lawsuits where the selected large companies are represented by tracked Law Firms; and
updating the relational legal database with the selected large companies associated with tracked Lawsuits.

2. A system and method for gathering and analyzing litigation marketplace intelligence data that facilitates transfer of data from court docket databases to a customer relationship management program using an online, on-demand productivity application, as described.
